(19) United States
(12) Patent Application Publication
(10) Pub. No.: US 2007/0092111 A1
(43) Pub. Date: Apr. 26, 2007

(54) Motion vector field re-timing

(76) Inventors: Rimmert B. Wittebrood, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/571,808

(22) PCT Filed: Aug. 31, 2004
(86) PCT No.: PCT/IB04/51619

§ 371 Date: Mar. 15, 2006

(30) Foreign Application Priority Data
Sep. 17, 2003 (EP) 03103425.9

(51) Int. Cl. G06K 9/00; H04N 5/14

(52) U.S. Cl. 382/107; 348/699

(57) ABSTRACT

A method of estimating a particular motion vector (D_{R}(x, n+α)) for a particular pixel, having a particular spatial position and being located at a temporal position (n+α) intermediate a first image and a second image of a sequence of video images, on basis of a first motion vector field (D₃(x, n−1)) being estimated for the first image and on basis of a second motion vector field (D₃(x, n)) being estimated for the second image is disclosed. The method comprises: creating a set of motion vectors (Dₚ, Dₙ, D_{c}) by selecting a number of motion vectors from the first motion vector field (D₃(x, n−1)) and second motion vector field (D₃(x, n)), on basis of the particular spatial position of the particular pixel; and establishing the particular motion vector (D_{R}(x,n+α)) by performing an order statistical operation on the set of motion vectors (Dₚ, Dₙ, D_{c}).

The invention relates to a method of estimating a particular motion vector for a particular pixel, having a particular spatial position and being located at a temporal position intermediate a first image and a second image of a sequence of video images, on basis of a first motion vector field being estimated for the first image and on basis of a second motion vector field being estimated for the second image.

The invention further relates to a motion estimation unit for estimating a particular motion vector for a particular pixel, having a particular spatial position and being located at a temporal position intermediate a first image and a second image of a sequence of video images, on basis of a first motion vector field being estimated for the first image and on basis of a second motion vector field being estimated for the second image.

The invention further relates to an image processing apparatus comprising:

receiving means for receiving a signal corresponding to a sequence of video images;

motion estimation means for estimating a first motion vector field for a first one of the video images and a second motion vector field for a second one of the video images;

a motion estimation unit for estimating a particular motion vector, as described above; and

an image processing unit for calculating a sequence of output images on basis of the sequence of video images and the particular motion vector.

The invention further relates to a computer program product to be loaded by a computer arrangement, comprising instructions to estimate a particular motion vector for a particular pixel, having a particular spatial position and being located at a temporal position intermediate, a first image and a second image of a sequence of video images, on basis of a first motion vector field being estimated for the first image and on basis of a second motion vector field being estimated for the second image, the computer arrangement comprising processing means and a memory.

With occlusion area is meant, an area which corresponds with a portion of a scene being captured, that is visible in an image of a series of consecutive images but that is not visible in a next or previous image. This is caused by the fact that foreground objects in the scene, which are located more close to the camera than background objects, can cover portions of the background objects. In the case of movement of e.g. the foreground objects some portions of the background objects get occluded, while other portions of the background objects get uncovered.

Occlusion areas can cause artifacts in temporal interpolations. E.g. in the case of up-conversion, occlusion areas can result in so-called halos. In the case of up-conversion, motion vectors are estimated in order to compute up-converted output images by means of temporal interpolation. For temporal interpolation, i.e. the computation of a new image intermediate two original input images, a number of pixels, which preferably relate to one and the same object are taken from consecutive images. This can not be done straightforward in the case of occlusion areas, because no related pixels can be found in both consecutive images. Other interpolation strategies are required, typically based on interpolation of pixel values of only a previous or next original image. It will be clear that the estimation of suitable motion vectors for occlusion areas is important.

An embodiment of the unit of the kind described in the opening paragraph is known from WO 01/88852. The known apparatus for detecting motion at a temporal intermediate position between a previous image and a next image has optimizing means for optimizing a criterion function for candidate motion vectors, whereby the criterion function depends on data from both the previous and next image. The motion is detected at the temporal intermediate position in non-covering and in non-uncovering areas. The known apparatus has means for detecting covering and uncovering areas and has its optimizing means being arranged to carry out the optimizing at the temporal position next in covering areas and at the temporal position of the previous image in uncovering areas.

It is an object of the invention to provide a method of the kind described in the opening paragraph which is relatively robust.

This object of the invention is achieved in that the method comprises:

creating a set of motion vectors by selecting a number of motion vectors from the first motion vector field and second motion vector field, on basis of the particular spatial position of the particular pixel; and

establishing the particular motion vector by performing an order statistical operation on the set of motion vectors.

Preferably the order statistical operation is a median operation. The method according to the invention is based on selection of an appropriate motion vector for the intermediate motion vector field from a set of motion vectors, comprising motion vectors being computed for images of the sequence of original input images. The probability that correct motion vectors are estimated for these original input images is relatively high. In particular when these motion vectors have been estimated on basis of three or more input images. The direct estimation of a motion vector for an intermediate temporal position on basis of two input images in general results into erroneous motion vectors for occlusion areas. Applying the motion vectors being estimated for a previous and a next original image results in a robust motion vector field for the intermediate temporal position. Optionally, an initial motion vector being initially estimated for the intermediate temporal position is used as element of the set of motion vectors and/or used to determine which motion vectors of the images of the sequence of original input images have to be selected.

In an embodiment of the method according to the invention, creating the set of motion vectors comprises selecting a first motion vector being estimated for the first image, having a first spatial position which corresponds to the particular spatial position of the particular pixel. In other words, on basis of a null vector, the first motion vector being estimated for the first image is selected. An advantage of this embodiment according to the invention is that no initial computation of the intermediate motion vector field is required. Preferably, the selected first motion vector is subsequently used to select further motion vectors for the creation of the set. Hence, preferably creating the set of motion vectors comprises selecting a second motion vector being estimated for the first image, having a second spatial position which is determined by the particular spatial position of the particular pixel and the first motion vector being selected and creating the set of motion vectors comprises selecting a third motion vector being estimated for the second image, having a third spatial position which is determined by the particular spatial position of the particular pixel and the first motion vector being selected.

In an embodiment of the method according to the invention, creating the set of motion vectors comprises selecting a second motion vector being estimated for the first image, having a second spatial position which is determined by the particular spatial position of the particular pixel and a first motion vector being estimated for the particular pixel. Preferably, creating the set of motion vectors comprises selecting a third motion vector being estimated for the second image, having a third spatial position which is determined by the particular spatial position of the particular pixel and the first motion vector being estimated for the particular pixel.

In an embodiment of the method according to the invention, creating the set of motion vectors comprises selecting a second motion vector being estimated for the second image, having a second spatial position which corresponds to the particular spatial position of the particular pixel. An advantage of this embodiment according to the invention is that the selection of the first and second motion vector is straight forward, i.e. based on the particular spatial position. Preferably, creating the set of motion vectors further comprises selecting a third motion vector being estimated for the first image, having a third spatial position and a fourth motion vector being estimated for the first image, having a fourth spatial position, the first spatial position, the third spatial position and the fourth spatial position being located on a line. Preferably, the motion vectors being selected from the second motion vector field are located on a second line. The orientation of the first line corresponds with the first motion vector and the orientation of the second line corresponds with the second motion vector. An advantage of creating the set of motion vectors by means of selecting a relatively large number or motion vectors in a spatial neighborhood of the first spatial position and the second spatial position is robustness. The number of selected motion vectors per motion vector field, i.e. the aperture of the filter for performing the order statistical operation is related with the expected maximum movement, i.e. the size of the maximum motion vectors.

An embodiment of the method according to the invention comprises up-conversion of a first intermediate motion vector field into the first motion vector field, the first motion vector field having a higher resolution than the first intermediate motion vector field, and comprises up-conversion of a second intermediate motion vector field into the second motion vector field, the second motion vector field having a further higher resolution than the second intermediate motion vector field. This up-conversion is preferably performed by means of a so-called block-erosion. Block erosion is a known method to compute different motion vectors for the pixels of a particular block on basis of the motion vector of the particular block of pixels and motion vectors of neighboring blocks of pixels. Block erosion is e.g. disclosed in the US patent specification U.S. Pat. No. 5,148,269. By increasing the resolution, more motion vectors are created in the spatial neighborhood of the first spatial position and the second spatial position, resulting in a more reliable particular motion vector.

It is a further object of the invention to provide a motion estimation unit of the kind described in the opening paragraph which is relatively robust.

This object of the invention is achieved in that the motion estimation unit comprises:

set creating means for creating a set of motion vectors by selecting a number of motion vectors from the first motion vector field and second motion vector field, on basis of the particular spatial position of the particular pixel; and

establishing means for establishing the particular motion vector by performing an order statistical operation on the set of motion vectors.

It is a further object of the invention to provide an image processing apparatus of the kind described in the opening paragraph comprising a motion estimation unit which is relatively robust.

This object of the invention is achieved in that the motion estimation unit comprises:

set creating means for creating a set of motion vectors by selecting a number of motion vectors from the first motion vector field and second motion vector field, on basis of the particular spatial position of the particular pixel; and

establishing means for establishing the particular motion vector by performing an order statistical operation on the set of motion vectors.

Optionally, the image processing apparatus further comprises a display device for displaying the output images. The image processing apparatus might e.g. be a TV, a set top box, a VCR (Video Cassette Recorder) player, a satellite tuner, a DVD (Digital Versatile Disk) player or recorder.

It is a further object of the invention to provide computer program product of the kind described in the opening paragraph which is relatively robust.

This object of the invention is achieved in that the computer program product, after being loaded, provides said processing means with the capability to carry out:

creating a set of motion vectors by selecting a number of motion vectors from the first motion vector field and second motion vector field, on basis of the particular spatial position of the particular pixel; and

establishing the particular motion vector by performing an order statistical operation on the set of motion vectors.

Modifications of the motion estimation unit and variations thereof may correspond to modifications and variations thereof of the image processing apparatus, the method and the computer program product, being described.

These and other aspects of the motion estimation unit, of the image processing apparatus, of the method and of the computer program product, according to the invention will become apparent from and will be elucidated with respect to the implementations and embodiments described hereinafter and with reference to the accompanying drawings, wherein:

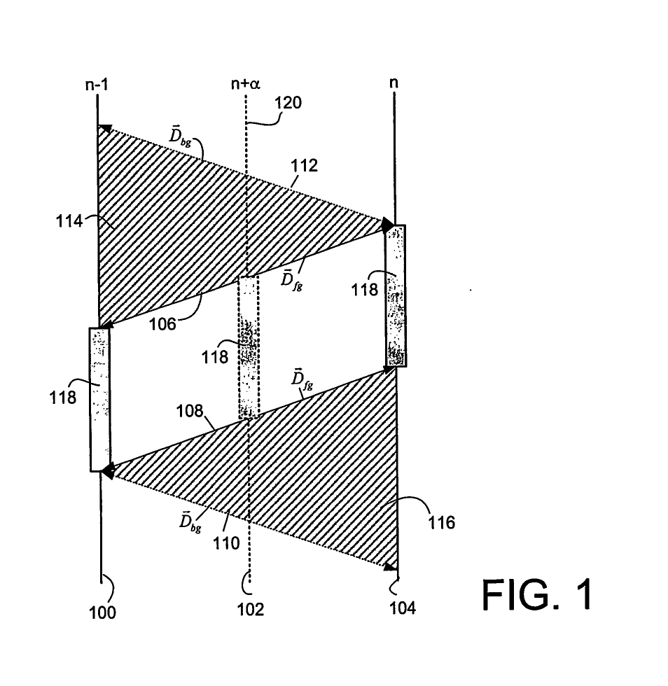

FIG. 1 schematically shows movement of a foreground object and movement of the background in a scene;

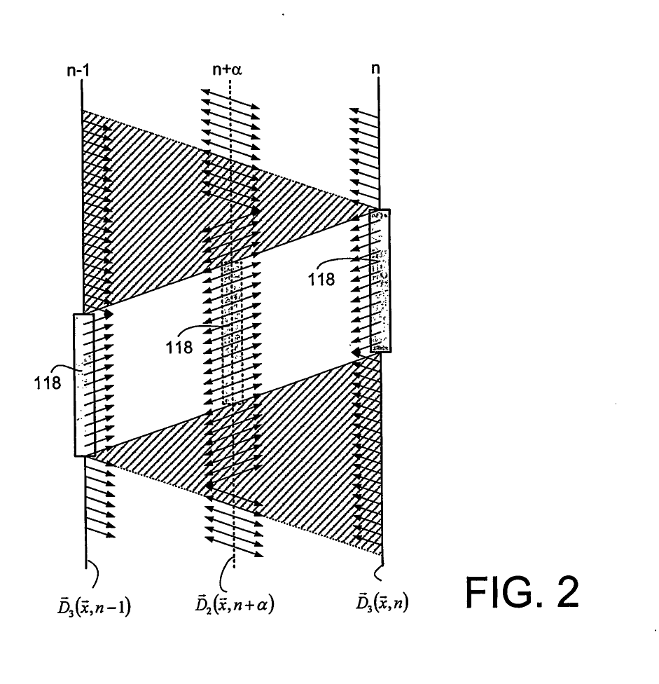

FIG. 2 schematically shows motion vector fields being estimated for the images shown in FIG. 1;

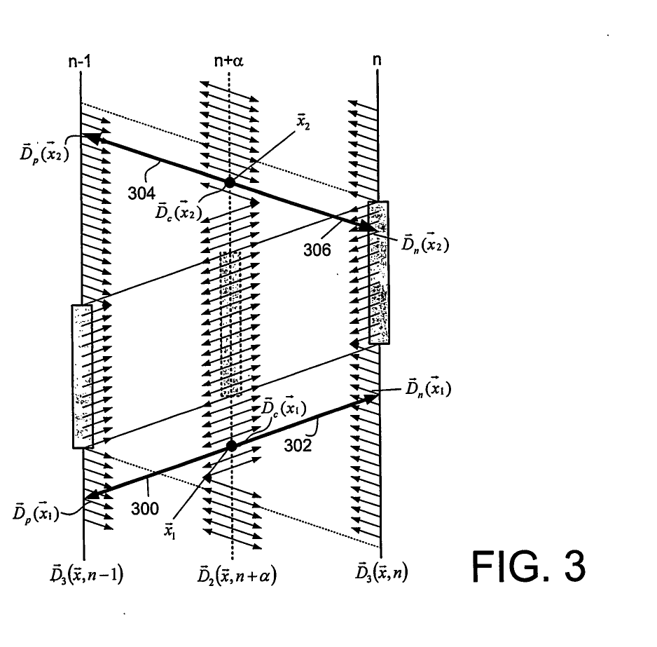

FIG. 3 schematically shows the method according to the invention for two example pixels;

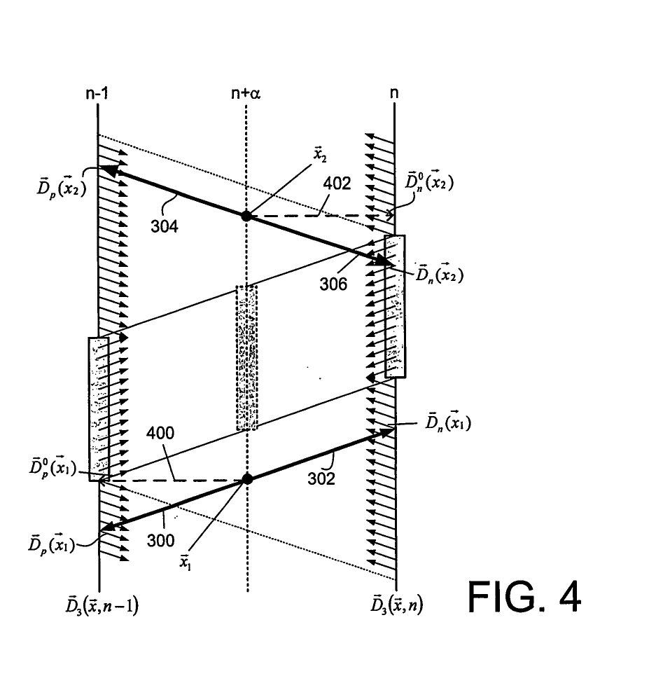

FIG. 4 schematically shows the method according to the invention for two example pixels in the case that no initial motion vector field has been computed for the intermediate temporal position;

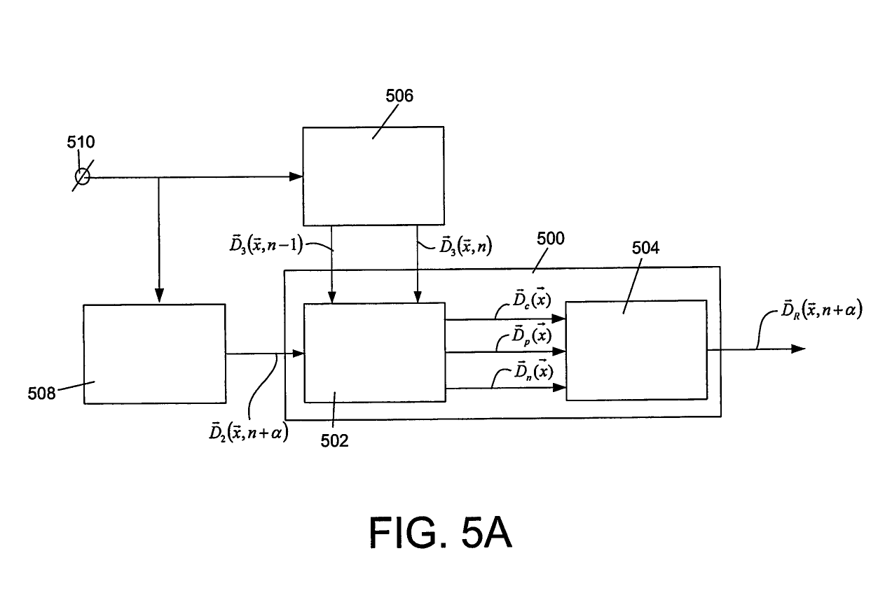

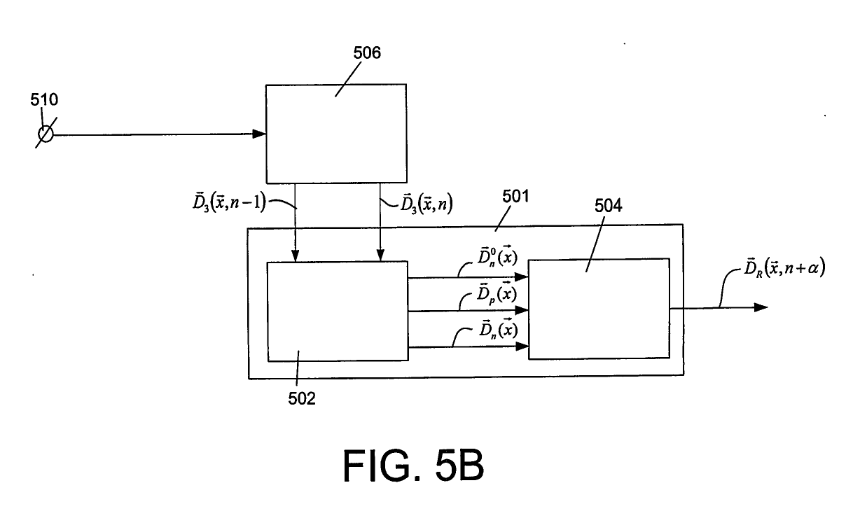

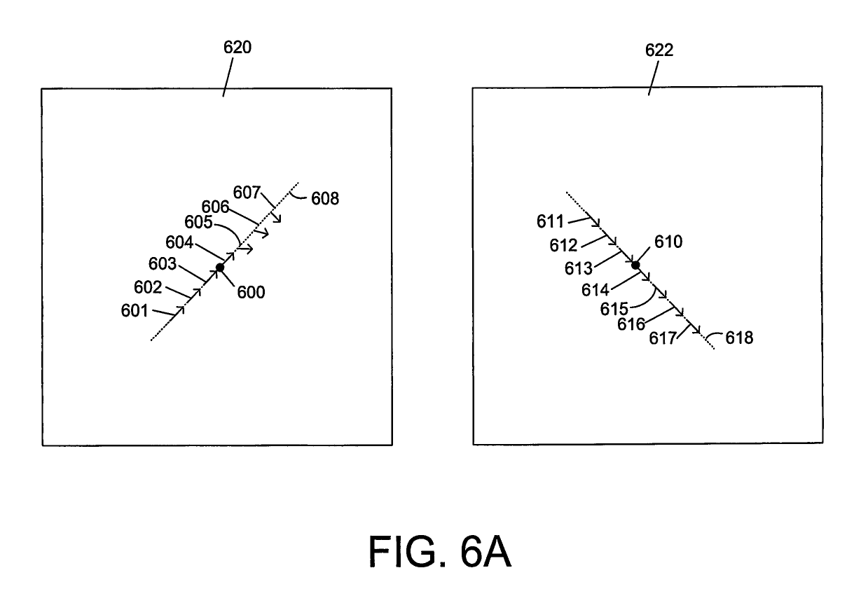

FIG. 5A schematically shows an embodiment of the motion estimation unit according to the invention, being provided with three motion vector fields;

FIG. 5B schematically shows an embodiment of the motion estimation unit according to the invention, being provided with two motion vector fields;

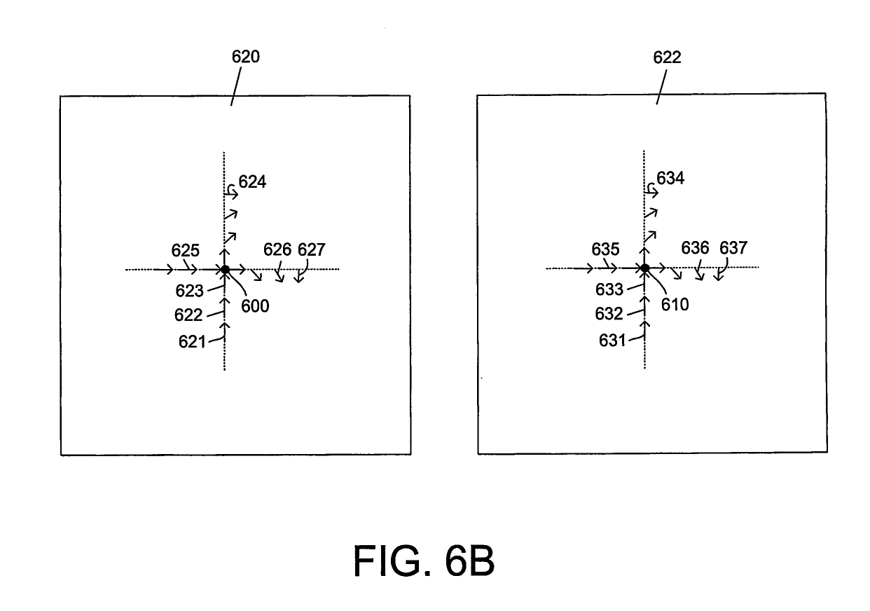

FIG. 6A schematically shows the creation of the set of motion vectors being applied in an embodiment according to the invention;

FIG. 6B schematically shows the creation of the set of motion vectors being applied in an alternative embodiment according to the invention; and

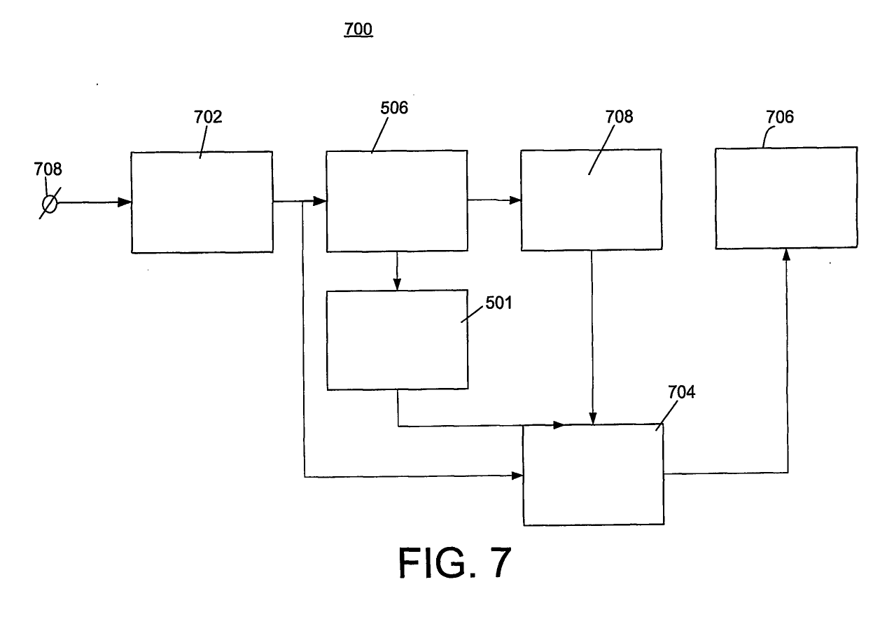

FIG. 7 schematically shows an embodiment of the image processing apparatus according to the invention.

Same reference numerals are used to denote similar parts throughout the Figures.

FIG. 1 schematically shows movement of a foreground object 118 and movement of the background in a scene. In FIG. 1 two original images 100 and 104 at temporal position n−1 and n are depicted. An object 118 within these images is moving in an upwards direction \vec{D}_{fg}, which is denoted by the gray rectangles connected by the solid black lines 106 and 108. The long narrow dotted black lines 110 and 112 indicate the motion of the background \vec{D}_{bg}, which is downwards. The hatched regions 114 and 116 indicate occlusion areas. A new image 102, which has to be created at temporal position n+α with −1≦α≦0 is indicated by the dashed line 120.

FIG. 2 schematically shows motion vector fields being estimated for the images shown in FIG. 1. i.e. the estimated motion vector fields are indicated by the arrows. A first motion vector field is estimated for the first 100 of the two original images and a second motion vector field is estimated for the second 104 of the two original images. These two motion vector fields are computed by means of a three-frame motion estimator. The first motion vector field is denoted by \vec{D}₃(x, n−1). This first motion vector field is estimated between luminance frames F(\vec{x}, n−2), F(\vec{x},n−1) and F(\vec{x}, n). The second motion vector field is denoted by \vec{D}₃(\vec{x},n). This second motion vector field is estimated between luminance frames F(\vec{x}, n−1), F(\vec{x},n) and F(\vec{x},n+1). Besides that an initial motion vector field has been computed for the temporal position n+α intermediate the first and second motion vector field. This initial motion vector field \vec{D}₂(\vec{x}, n+α) is estimated between luminance frames F(\vec{x},n−1) and F(\vec{x},n). Note that the motion vector fields \vec{D}₃(\vec{x},n−1) and \vec{D}₃(\vec{x},n) of the three-frame motion estimator substantially match with the foreground object 118, whereas the motion vector field \vec{D}₂(\vec{x}, n+α) of the two-frame motion estimator shows foreground vectors which extends into the background.

According to the method of the invention a final motion vector field \vec{D}_{R}(\vec{x}, n+α) can be computed by using the three motion vector fields \vec{D}₃(\vec{x},n−1), \vec{D}₃(\vec{x},n) and \vec{D}₂(\vec{x}, n+α), which has appropriate motion vectors at all locations, i.e. also in covering and uncovering areas. That means that the back-ground vector is determined in occlusion areas. This final motion vector field \vec{D}_{R}(\vec{x}, n+α) is preferably created by taking the median of the motion vector from the two-frame motion estimator \vec{D}_{c}=\vec{D}₂(x, n+α) and the motion vectors fetched with vector \vec{D}_{c} from the motion vector fields \vec{D}₃(\vec{x}, n−1) and \vec{D}₃(\vec{x},n). These latter vectors are denoted by \vec{D}ₚ=\vec{D}₃(\vec{x}−(α+1)\vec{D}_{c},n−1) and \vec{D}ₙ=\vec{D}₃(\vec{x}−α \vec{D}_{c},n). The median is specified in Equation 1:
\vec{D}_{R}(\vec{x},n+α)=med(\vec{D}_{c},\vec{D}ₚ,\vec{D}ₙ) (1)
where the “med” operator can be a vector median or a median over the vector components separately. In case the motion vectors are subpixel accurate, preferably suitable interpolation is performed. The vector median operation is as specified in the article “Vector median filters”, by J. Astola et al. in Proceedings of the IEEE, 78:678-689, April 1990. A vector median can be specified by means of Equations 2 and 3. Let,

$$Δ ( \vec{D} ) = {\sum }_{k} \vert \vec{D} - {\vec{D}}_{k} \vert \\ then , \\ {\vec{D}}_{median} = \{ \vec{D} \vert arg {min ( Δ ( \vec{D} ) )}_{\vec{D}} \} \qquad ( 2 )$$

FIG. 3 schematically shows the method according to the invention for two example pixels at spatial positions \vec{x}₁, and \vec{x}₂, respectively. First consider the situation around the pixel at location \vec{x}₁. The motion vector \vec{D}_{c}(\vec{x}₁) from the initial motion vector field \vec{D}₂(\vec{x}, n+α) is used to fetch the motion vectors \vec{D}ₚ(\vec{x}₁) and \vec{D}ₙ(\vec{x}₁) from the first vector field \vec{D}₃(\vec{x}, n−1) and the second motion vector field \vec{D}₃(\vec{x}, n), respectively. This selection process is indicated by the thick black arrows 300 and 302, respectively. The motion vector from \vec{D}_{c}(\vec{x}₁) from the initial motion vector field \vec{D}₂(\vec{x}, n+α) is the foreground vector, but since both fetched vectors \vec{D}ₚ(\vec{x}₁) and \vec{D}ₙ(\vec{x}₁) are background vectors, the median operator will select the background vector.

A similar process can be used to establish the appropriate motion vector for the other pixel at location \vec{x}₂. The motion vector \vec{D}ₚ(\vec{x}₂) from the initial motion vector field \vec{D}₂(\vec{x}, n+α) is used to fetch the motion vectors \vec{D}ₚ(\vec{x}₂) and \vec{D}ₙ(\vec{x}₂) from the first vector field \vec{D}₃(\vec{x},n−1) and the second motion vector field \vec{D}₃(\vec{x},n), respectively. This selection process is indicated by the thick black arrows 304 and 306, respectively. Here, the fetched motion vectors with \vec{D}ₚ(\vec{x}₂) and \vec{D}ₙ(\vec{x}₂) are background and foreground vectors, respectively. Since the motion vector \vec{D}_{c}(\vec{x}₂) from the initial motion vector field \vec{D}₂(\vec{x},n+α) is a background vector too, the median operator will again select the background vector.

In connection with FIGS. 2 and 3 is described that the motion vector field for temporal position n+α has been determined on basis of the initial motion vector field \vec{D}₂(\vec{x},n+α). FIG. 4 schematically shows the method according to the invention for two example pixels in the case that no initial motion vector field \vec{D}₂(\vec{x},n+α) has been computed for the intermediate temporal position. The example pixels are located at spatial positions \vec{x}₁ and \vec{x}₂, respectively.

First consider the situation around the pixel at location \vec{x}₁. The motion vector \vec{D}ₚ⁰(x₁) from the first motion vector field \vec{D}₃(\vec{x},n−1) is used to fetch the motion vectors \vec{D}ₚ(\vec{x}₁) and \vec{D}ₙ(\vec{x}₁) from the first vector field \vec{D}₃(\vec{x}, n−1) and the second motion vector field \vec{D}₃(\vec{x}, n), respectively. The motion vector \vec{D}ₚ⁰(\vec{x}₁) is found on basis of the null motion vector and the spatial position \vec{x}₁ of the first pixel. This is indicated with the dashed arrow 400. The selection process is indicated by the thick black arrows 300 and 302, respectively. The motion vector \vec{D}ₚ⁰(\vec{x}₁) is the foreground vector, but since both fetched vectors \vec{D}ₚ(\vec{x}₁) and \vec{D}ₙ(\vec{x}₁) are background vectors, the median operator will select the background vector.

A similar process can be used to establish the appropriate motion vector for the other pixel at location \vec{x}₂. The motion vector \vec{D}ₙ⁰(\vec{x}₂) from the second motion vector field \vec{D}₃(\vec{x},n) is used to fetch the motion vectors \vec{D}ₚ(\vec{x}₂) and \vec{D}ₙ(\vec{x}₂) from the first vector field \vec{D}₃(\vec{x}, n−1) and the second motion vector field \vec{D}₃(\vec{x}, n), respectively. The motion vector \vec{D}ₙ⁰(\vec{x}₂) is found on basis of the null motion vector and the spatial position \vec{x}₂ of the second pixel. This is indicated with the dashed arrow 402. The selection process is indicated by the thick black arrows 304 and 306, respectively. Here, the fetched motion vectors \vec{D}ₚ(\vec{x}₂) and \vec{D}ₙ, (\vec{x}₂) are background and foreground vectors, respectively. Since the motion vector \vec{D}ₙ⁰(\vec{x}₂) is a background vector too, the median operator will again select the background vector.

FIG. 5A schematically shows an embodiment of the motion estimation unit 500 according to the invention, being arranged to compute a final motion vector field for a temporal position n+α. The motion estimation unit 500 is provided with three motion vector fields. The first \vec{D}₃(\vec{x}, n−1) and second \vec{D}₃(\vec{x},n) of these provided motion vector fields are computed by means of a three-frame motion estimator 506. An example of a three-frame motion estimator 506 is disclosed in U.S. Pat. No. 6,011,596. The third provided motion vector field \vec{D}₂(\vec{x},n+α) is computed by means of a two-frame motion estimator 508. This two-frame motion estimator 508 is e.g. as specified in the article “True-Motion Estimation with 3-D Recursive Search Block Matching” by G. de Haan et al. in IEEE Transactions on circuits and systems for video technology, vol. 3, no. 5, October 1993, pages 368-379.

The motion estimation unit 500 according to the invention is arranged to estimate a particular motion vector for a particular pixel and comprises:

a set creating unit 502 for creating a set of motion vectors \vec{D}ₚ, \vec{D}ₙ and \vec{D}_{c} by selecting a number of motion vectors from the first motion vector field \vec{D}₃(\vec{x}, n−1), the second motion vector field \vec{D}₃(\vec{x}, n) and the third motion vector field \vec{D}₂(\vec{x},n+α), respectively on basis of the particular spatial position of the particular pixel; and

an establishing unit 504 for establishing the particular motion vector \vec{D}_{R}(\vec{x},n+α) by performing an order statistical operation on the set of motion vectors.

The working of the motion estimation unit 500 according to the invention is as described in connection with FIG. 3.

The three-frame motion estimator 506, the two-frame motion estimator 508, the set creating unit 502 and the establishing unit 504 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 5B schematically shows an alternative embodiment of the motion estimation unit 501 according to the invention. This motion estimation unit 501 is also called a motion vector re-timing unit 501, because the motion vector re-timing unit 501 is arranged to compute a final motion vector field for a temporal position n+α, being intermediate to two provided motion vector fields \vec{D}₃(\vec{x}, n−1) and \vec{D}₃(\vec{x},n) which are located at temporal positions n−1 and n, respectively. The first \vec{D}₃(\vec{x},n−1) and second \vec{D}₃(\vec{x},n) of these provided motion vector fields are computed by means of a three-frame motion estimator 506. An example of a three-frame motion estimator 506 is disclosed in U.S. Pat. No. 6,011,596.

The motion estimation unit 501 according to the invention is arranged to estimate a particular motion vector for a particular pixel and comprises:

a set creating unit 502 for creating a set of motion vectors \vec{D}ₚ, \vec{D}ₙ, and \vec{D}ₙ⁰ by selecting a number of motion vectors from the first motion vector field \vec{D}₃(\vec{x}, n−1) and the second motion vector field \vec{D}₃(\vec{x}, n), respectively, on basis of the particular spatial position of the particular pixel; and

an establishing unit 504 for establishing the particular motion vector \vec{D}_{R}(\vec{x}, n+α) by performing an order statistical operation on the set of motion vectors.

The working of the motion estimation unit 501 according to the invention is as described in connection with FIG. 4.

It should be noted that the number of motion vectors in the set of motion vectors being created in the motion estimation unit according to the invention might be higher than the three motion vectors in the examples as described in connection with FIGS. 3 and 4.

The computation of motion vectors for the different temporal positions n−1, n+α and n is preferably performed synchronously. That means that a particular motion vector field, e.g. for temporal position n−1 does not necessarily correspond to the group of motion vectors which together represent the motion of all pixels of the corresponding original input video image. In other words, a motion vector field might corresponds to a group of motion vectors which together represent the motion of a portion of the pixels, e.g. only 10% of the pixels of the corresponding original input video image.

FIG. 6A schematically shows the creation of the set of motion vectors being applied in an embodiment according to the invention. FIG. 6A schematically shows a first motion vector field 620 being estimated for a first image and a second motion vector field 622 being estimated for a second image. The a set of motion vectors is created by selecting a number of motion vectors from the first motion vector field 620 and the second motion vector field, on basis of the particular spatial position of the particular pixel for which a particular motion vector has to be established. The particular pixel is located at a temporal position (n+α) intermediate the first image and the second image of a sequence of video images. The set of motion vectors comprises a first sub-set of motion vectors 601-607 selected from the first motion vector field 620. This first sub-set is based on a first spatial position 600 in the first image, which corresponds to the particular spatial position and is based on the first motion vector 604 belonging to the first spatial position. On basis of the first motion vector 604 a line 608 is defined. On this line a first number of motion vectors is selected to make the first sub-set of motion vectors 601-607. Typically the first sub-set comprises 9 motion vectors. The selected first number of motion vectors is preferably centered around the first spatial position 600 in the first image. Alternatively, the selection is not centered around the first spatial position 600 but shifted on the line 608 in the direction of the first motion vector 604.

The set of motion vectors comprises a second sub-set of motion vectors 611-617 selected from the second motion vector field 620. This second sub-set is based on a second spatial position 610 in the second image, which corresponds to the particular spatial position and is based on the second motion vector 614 belonging to the second spatial position. On basis of the second motion vector 614 a line 618 is defined. On this line a second number of motion vectors is selected to make the second sub-set of motion vectors 611-617. Typically the second sub-set also comprises 9 motion vectors. The selected second number of motion vectors is preferably centered around the second spatial position 610 in the second image. Alternatively, the selection is not centered around the second spatial position 610 but shifted on the line 618 in the direction of the second motion vector 614.

Alternatively, the set of motion vectors comprises another second sub-set of motion vectors selected from the second motion vector field. (These motion vectors are not depicted). This other second sub-set is based on a second spatial position 610 in the second image, which corresponds to the particular spatial position and is based on the first motion vector 604 belonging to the first spatial position. On basis of the first motion vector 604 a line is defined. On this line a second number of motion vectors is selected to make the other second sub-set of motion vectors. Typically the second sub-set also comprises 9 motion vectors.

Eventually, the particular motion vector is established by performing an order statistical operation on the set of motion vectors, e.g. 601-607, 611-617. Preferably the order statistical operation is a median operation. Optionally the median is a so-called a weighted or central weighted median operation. That means that the set of motion vectors comprises multiple motion vectors corresponding to the same spatial position. E.g. the set of motion vectors comprises multiple instances of the first motion vector and of the second motion vector. Suppose that in total 9 motion vectors 601-607 are selected from the first motion vector field 620, then the set might comprises 9 instances of the first motion vector 604.

FIG. 6B schematically shows the creation of the set of motion vectors being applied in an alternative embodiment according to the invention. FIG. 6B schematically shows a first motion vector field 620 being estimated for a first image and a second motion vector field 622 being estimated for a second image. The a set of motion vectors is created by selecting a number of motion vectors from the first motion vector field 620 and the second motion vector field, on basis of the particular spatial position of the particular pixel for which a particular motion vector has to be established.

The set of motion vectors comprises a first sub-set of motion vectors 621-627 selected from the first motion vector field 620. This first sub-set is based on a first spatial position 600 in the first image, which corresponds to the particular spatial position. Relative to this first spatial position a first number of motion vectors is selected to make the first sub-set of motion vectors 621-627.

The set of motion vectors comprises a second sub-set of motion vectors 631-637 selected from the second motion vector field 622. This second sub-set is based on a second spatial position 610 in the second image, which corresponds to the particular spatial position. Relative to this second spatial position a second number of motion vectors is selected to make the second sub-set of motion vectors 631-637.

Eventually, the particular motion vector is established by performing an order statistical operation on the set of motion vectors 621-627, 631-637. Preferably the order statistical operation is a median operation. Optionally the median is a so-called a weighted or central weighted median operation.

Alternatively, two order statistical operations are performed on basis of two different components sets. This works as follows. A first sub-set of horizontal components of motion vectors is created by taking the horizontal components of a first number of motion vectors 625-627 of the first motion vector field 620 and a second sub-set of horizontal components of motion vectors is created by taking the horizontal components of the first number of motion vectors 635-637 of the second motion vector field 622. From the total set of horizontal components the horizontal component of the particular motion vector is determined by means of an order statistical operation. A first sub-set of vertical components of motion vectors is created by taking the vertical components of a first number of motion vectors 621-624 of the first motion vector field 620 and a second sub-set of vertical components of motion vectors is created by taking the vertical components of the first number of motion vectors 631-634 of the second motion vector field 622. From the total set of vertical components the vertical component of the particular motion vector is determined by means of an order statistical operation.

FIG. 7 schematically shows an embodiment of the image processing apparatus 700 according to the invention, comprising:

receiving means 702 for receiving a signal corresponding to a sequence of video images;

a motion estimation unit 506 for estimating a first motion vector field for a first one of the video images and a second motion vector field for a second one of the video images;

a motion vector re-timing unit 501, as described in connection with FIG. 5B;

an occlusion detector 708 for detecting areas of covering and uncovering, the occlusion detector 708 e.g. as described in WO 03/041416 or in WO 00/11863;

an image processing unit 704 for calculating a sequence of output images on basis of the sequence of video images, the motion vector field being provided by the motion vector re-timing unit 501 and the occlusion map being provided by the occlusion detector 708; and

a display device 706 for displaying the output images of the image processing unit 704.

The signal may be a broadcast signal received via an antenna or cable but may also be a signal from a storage device like a VCR (Video Cassette Recorder) or Digital Versatile Disk (DVD). The signal is provided at the input connector 708. The image processing apparatus 700 might e.g. be a TV. Alternatively the image processing apparatus 700 does not comprise the optional display device but provides the output images to an apparatus that does comprise a display device 706. Then the image processing apparatus 700 might be e.g. a set top box, a satellite-tuner, a VCR player, a DVD player or recorder. Optionally the image processing apparatus 700 comprises storage means, like a hard-disk or means for storage on removable media, e.g. optical disks. The image processing apparatus 700 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A method of estimating a particular motion vector (\vec{D}_{R}(\vec{x},n+α)) for a particular pixel, having a particular spatial position and being located at a temporal position (n+α) intermediate a first image and a second image of a sequence of video images, on basis of a first motion vector field {right arrow over (()}D₃ (\vec{x},n−1)) being estimated for the first image and on basis of a second motion vector field (\vec{D}₃ (\vec{x}, n−1)) being estimated for the second image, the method comprising:
creating a set of motion vectors (\vec{D}ₚ, \vec{D}ₙ,\vec{D}_{c}) by selecting a number of motion vectors from the first motion vector field (\vec{D}₃ (\vec{x}, n−1)) and second motion vector field (\vec{D}₃ (\vec{x},n)), on basis of the particular spatial position of the particular pixel; and
establishing the particular motion vector (\vec{D}_{R}(\vec{x}, n+α)) by performing an order statistical operation on the set of motion vectors (\vec{D}ₚ, \vec{D}ₙ, \vec{D}_{c}).

2. A method of estimating a particular motion vector as claimed in claim 1, wherein the order statistical operation is a median operation.

3. A method of estimating a particular motion vector as claimed in claim 1, wherein creating the set of motion vectors comprises selecting a first motion vector being estimated for the first image, having a first spatial position which corresponds to the particular spatial position of the particular pixel.

4. A method of estimating a particular motion vector as claimed in claim 3, wherein creating the set of motion vectors comprises selecting a second motion vector being estimated for the first image, having a second spatial position which is determined by the particular spatial position of the particular pixel and the first motion vector being selected.

5. A method of estimating a particular motion vector as claimed in claim 4, wherein creating the set of motion vectors comprises selecting a third motion vector being estimated for the second image, having a third spatial position which is determined by the particular spatial position of the particular pixel and the first motion vector being selected.

6. A method of estimating a particular motion vector as claimed in claim 1, wherein creating the set of motion vectors comprises selecting a second motion vector being estimated for the first image, having a second spatial position which is determined by the particular spatial position of the particular pixel and a first motion vector being estimated for the particular pixel.

7. A method of estimating a particular motion vector as claimed in claim 6, wherein creating the set of motion vectors comprises selecting a third motion vector being estimated for the second image, having a third spatial position which is determined by the particular spatial position of the particular pixel and the first motion vector being estimated for the particular pixel.

8. A method of estimating a particular motion vector as claimed in claim 3, wherein creating the set of motion vectors comprises selecting a second motion vector being estimated for the second image, having a second spatial position which corresponds to the particular spatial position of the particular pixel.

9. A method of estimating a particular motion vector as claimed in claim 8, wherein creating the set of motion vectors comprises selecting a third motion vector being estimated for the first image, having a third spatial position and a fourth motion vector being estimated for the first image, having a fourth spatial position, the first spatial position, the third spatial position and the fourth spatial position being located on a line.

10. A method of estimating a particular motion vector as claimed in claim 9, wherein an orientation of the line corresponds with the first motion vector.

11. A method of estimating a particular motion vector as claimed in claim 1, wherein the method comprises up-conversion of a first intermediate motion vector field into the first motion vector field, the first motion vector field having a higher resolution than the first intermediate motion vector field, and comprises up-conversion of a second intermediate motion vector field into the second motion vector field, the second motion vector field having a further higher resolution than the second intermediate motion vector field.

12. A motion estimation unit (501) for estimating a particular motion vector for a particular pixel, having a particular spatial position and being located at a temporal position intermediate a first image and a second image of a sequence of video images, on basis of a first motion vector field being estimated for the first image and on basis of a second motion vector field being estimated for the second image, the motion estimation unit comprising:
set creating means (502) for creating a set of motion vectors by selecting a number of motion vectors from the first motion vector field and second motion vector field, on basis of the particular spatial position of the particular pixel; and
establishing means (504) for establishing the particular motion vector by performing an order statistical operation on the set of motion vectors.

13. An image processing apparatus (700) comprising:
receiving means (702) for receiving a signal corresponding to a sequence of video images;
motion estimation means (506) for estimating a first motion vector field for a first one of the video images and a second motion vector field for a second one of the video images;
a motion estimation unit (501) for estimating a particular motion vector for a particular pixel, having a particular spatial position and being located at a temporal position between the first one of the video images and the second one of the video images, the motion estimation unit comprising:
set creating means (502) for creating a set of motion vectors by selecting a number of motion vectors from the first motion vector field and second motion vector field, on basis of the particular spatial position of the particular pixel; and
establishing means (504) for establishing the particular motion vector by performing an order statistical operation on the set of motion vectors; and
an image processing unit (704) for calculating a sequence of output images on basis of the sequence of video images and the particular motion vector.

14. An image processing apparatus (700) as claimed in claim 13, further comprising a display device (406) for displaying the output images.

15. An image processing apparatus (700) as claimed in claim 14, being a TV.

16. A computer program product to be loaded by a computer arrangement, comprising instructions to estimate a particular motion vector for a particular pixel, having a particular spatial position and being located at a temporal position intermediate a first image and a second image of a sequence of video images, on basis of a first motion vector field being estimated for the first image and on basis of a second motion vector field being estimated for the second image, the computer arrangement comprising processing means and a memory, the computer program product, after being loaded, providing said processing means with the capability to carry out:
creating a set of motion vectors by selecting a number of motion vectors from the first motion vector field and second motion vector field, on basis of the particular spatial position of the particular pixel; and
establishing the particular motion vector by performing an order statistical operation on the set of motion vectors.
